(19) United States
(12) Patent Application Publication
(10) Pub. No.: US 2012/0153013 A1
(43) Pub. Date: Jun. 21, 2012

(54) Easy Open Bakeable Shipping Tray

(76) Inventor: Jeffrey S. Covelli, Delafield, WI (US)

(21) Appl. No.: 13/328,434

(22) Filed: Dec. 16, 2011

Related U.S. Application Data
(60) Provisional application No. 61/423,705, filed on Dec. 16, 2010.

(51) Int. Cl. B65D 25/00; B31B 1/26

(52) U.S. Cl. 229/100; 493/162

(57) ABSTRACT

A generally flat blank used to form an open-top container, the blank comprising a bottom panel bounded by end and side score lines, first and second side panels connected to the opposite sides of the bottom panel at the respective side score lines, each of the first and second side panels having a flap panel, each flap panel connected to each end panel by a hinged fold joint having a retaining slit, a first end panel connected to one end of the bottom panel at one score lines, a second end panel connected to the bottom panel opposite the first end panel and at least one locking extension connected to the second end panel having at least one locking member thereon that is releasably engageable with the retaining slit on the fold joint to selectively lock the second end panel with regard to the first and second side panels.

### CROSS-REFERENCE TO RELATED APPLICATIONS

This application claims priority from U.S. Provisional Patent Application Ser. No. 61/423,705, filed on Dec. 16, 2010, the entirety of which is expressly incorporated herein by reference.

### FIELD OF THE INVENTION

The present invention relates generally to a paperboard carton formed from a flat blank, and relates more specifically to a flat, die-cut blank of laminated paperboard or corrugated paperboard that can be formed into a tray, which tray can be used for baking, shipping and storing food and other products and eliminates the need for gluing or adhering, taping and the like to lock the walls of the tray in an upright configuration.

### BACKGROUND OF THE INVENTION

Conventional foldable paperboard, cardboard or other material cartons are well known and are used worldwide in a variety of applications. For example, the packaging industry utilizes a vast number of cartons in which numerous products are packaged for subsequent shipment. Similarly, a variety of automated carton erectors exist for folding cartons. Foldable cardboard carton erector devices are known for setting up folded carton or box blanks, closing their bottom flaps, and sealing the bottom flaps so the carton can be loaded. Many of the cartons folded by a box erector are commonly referred to as slotted boxes or cases known as a RSC (regular slotted case). These cartons are shipped to a packaging company as stacks of flat collapsed blanks for ease of handling and shipment. After arriving at the packaging company, the blanks are placed into a box erecting apparatus, usually located immediately adjacent a packaging machine. Box erectors automatically remove collapsed boxes individually from a magazine and, by various mechanisms, move a box to an unfolded open position. After being placed in this configuration, the erector automatically moves a pair of minor and major closure flaps on the bottom of the box into a closed position so the box, upon reaching the end of the erector, is in a top open position so that any articles to be contained therein can be inserted manually or automatically into the open top of the erected box.

Automated construction of foldable trays has been limited primarily to the high-speed production of like trays of the same size. For example, six-pack trays with or without a shrink wrap assist are well known and are produced in high speed and great volume. These types of trays are designed to retain the lower portion of the boxes, cartons or containers by providing a bottom and four secured sides. While these sides may be secured by a binding means like staples, adhesive is conventionally preferred since the tray is thus much more rigid and the possibility of injury to one's hand during emptying is greatly reduced due to the elimination of the staples.

The conventional binding method uses a thermally sealable coating or adhesive on the carton blank. The places of the carton or tray that are to be fastened together are coated and subsequently heated by hot air, and thereafter these places are subjected to pressure by clamping jaws, clamping rollers or the like to cure and secure the places using the adhesive or coating. During erection of these types of trays, the sides or flaps are laid one above the other and fastened by the heat and pressure.

Typical tray construction in an automated erector begins by manipulating a scored flat sheet or blank. While there may or may not be cutouts in the tray blank providing grip assists for lifting the tray, tray blanks generally have cutout portions that provide tabs that are folded to secure end and side walls. Conventionally, the erected tray has side and end walls of substantially the same height. In the conventional erection of a rectangular tray-type carton from a flat blank, it is known to fold the end and side wall panels of the carton approximately perpendicular from the bottom panel of the carton, and then to secure those panels in their desired formation by means of folded gussets formed from gusset panels which join the end and side wall panels integrally together.

The nature of paperboard and corrugated paperboard cartons, however, limits their use to post-preparation storage and handling of most food products. For example, typical paperboard and corrugated paperboard are generally inadequate for use during the baking or cooking of food items, as the materials from which they are constructed will burn or char at elevated temperatures.

In addition, the corrugated material utilized in making the cartons or trays has always been used to design trays that fold using the width panel and all folding over occurs on the width (or short) panel. This has always been done for ease of forming when erecting the tray.

However, there are certain shortcomings with regard to this design, such as an overall reduction in strength of the tray, allowing for bowing of the sidewalls of the tray. The shortcomings are compounded by the convention with regard to corrugated trays that the corrugations run parallel to the longer direction of the tray. While this is done to minimize any “false scores” from forming and potentially damaging the product held within the tray, this does allow significant bottom bowing to occur. The bottom bowing of trays is a problem in the baking industry because when the trays are column stacked in a corrugated box, the icing or other product disposed in a lower tray will come in contact with a bowed bottom panel from the tray immediately above the product.

Therefore, it can be seen that a need yet exists for a paperboard or corrugated paperboard tray container that can be formed from a blank by a compact and efficient automated erector, which tray can be used for baking, shipping and storing food and other products. The tray should be foldably constructed from a flat, die-cut blank, and should enable contents to be contained therein and also easily removed from the tray without having to rupture or otherwise disassemble the tray. In addition, the configuration of the tray should be such that sidewall and bottom bowing of the tray are reduced.

### SUMMARY OF THE INVENTION

Briefly described, one aspect of the present invention provides a tray formed from a generally flat, rectangular blank. The blank generally comprises: a bottom panel bounded by first and second end score lines and first and second side score lines; first and second end panels connected to the opposite ends of the bottom panel at the first and second end score lines; first and second side panels connected to the opposite sides of the bottom panel at the first and second side score lines; and corner webs or gussets adjacent a pair of corners of the bottom panel between a first end panel and the adjacent side panels. The tray also includes a pair of panel extensions disposed opposite the bottom panel on the longer portions of the tray, whether the longer panels are the side panels or the end panels. In the assembled portion of the tray, the extensions are folded over the side or end panels to which they are connected to form a reinforced side or end panel of the tray. This configuration of the tray with the reinforced, doubled over, longer or length panels of the tray provides the tray with added strength along the longer dimension of the tray. One advantage to the doubling over of the length panel (or whether the side or end panel) in the tray configuration of the present invention is that it creates a stronger tray with a corresponding reduction of sidewall bowing. By using the length panel folded over, the same square footage of corrugated material is used to form the tray as in a conventional tray with the width panel fold over, but the linear strength increases dramatically. This change in configuration and resulting strength increase accommodates a desire to be able cut product in the corrugated trays which cannot be accomplished with any bowing or deflection of the tray in the cutting process, or else the product will be miscut. Also, by doubling over the length panel and creating the increased strength provided by tray configuration of this disclosure, it is possible to reverse the corrugation in the tray to the short direction, conversely to prior art trays. This reduces any bottom bowing associated with prior art trays, and still functions to limit false scoring and the resulting damage to frozen product in the tray.

According to another aspect of the present invention, when the extensions are formed on the side panels, at one end of the tray formed by the first end panel, the erected tray has leak-proof corner assemblies formed where the corner web are folded against the associated side panel of the tray, and engaged with the first end panel.

According to a further aspect of the present invention, when the extensions are formed on the side panels, at the opposite end of the tray formed with the second end panel, the extensions are formed with a rounded shape and a pair of tabs or locking members thereon. The tabs are selectively engaged with notches or slits in the side walls of the tray. The engagement of the tabs enables the second end panel to pivot along the end score line connecting the second end panel to the bottom panel, thereby providing an opening mechanism for accessing the contents of the tray.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is a perspective view of a blank used to form one embodiment of the tray of the present disclosure;

FIG. 2 is a partially broken away perspective view of a pivoting corner web and side panel extension of the blank of FIG. 1;

FIG. 3 is a top perspective view of one embodiment of a tray formed using the blank of FIG. 1; and

FIG. 4 is a bottom perspective view of the tray of FIG. 3.

### DETAILED DESCRIPTION OF THE INVENTION

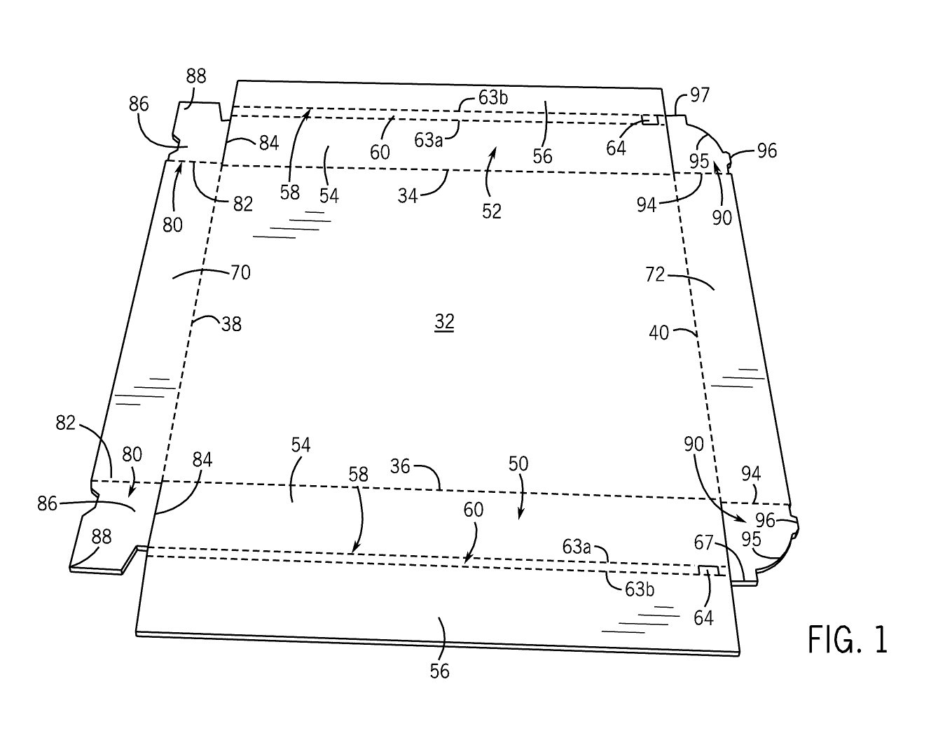

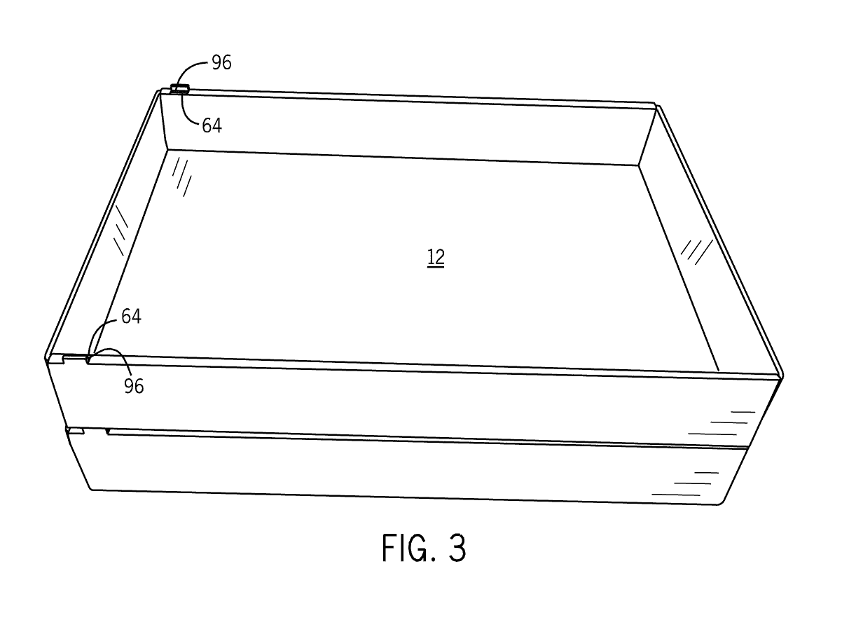

Referring now in detail to the drawing figures, wherein like reference numerals represent like parts throughout the several views, FIG. 1 shows a one-piece blank 30. The blank 30 is die cut and scored, according to known techniques, from a flat sheet of a suitable material, which in the illustrated embodiment is a heat-resistant laminated paperboard or corrugated paperboard having a laminated linerboard. The blank 30 comprises a heat-resistant laminated paperboard or corrugated paperboard, such as a corrugated paperboard known by the name E-flute, however, the blank 30 can be fabricated from any of a variety of foldable paperboard, cardboard, or other materials. In order to provide a leakproof and heat-resistant container, the material comprising the blank 30 is preferably a laminated composite including a layer of plastic film bonded to the paperboard, cardboard, or other material of construction. In one embodiment, a corrugated paperboard stock is provided with a layer of plastic film (not shown) on at least one of its faces. In the illustrated embodiment, the plastic film layer is provided on the interior of the baking sheet or tray 10 (FIG. 3) assembled from the blank 30 to prevent liquid content from being absorbed by, or from leaking through the baking sheet 10. Alternatively, the plastic film layer can be provided on the exterior of the baking sheet 10, or on both the interior and exterior thereof.

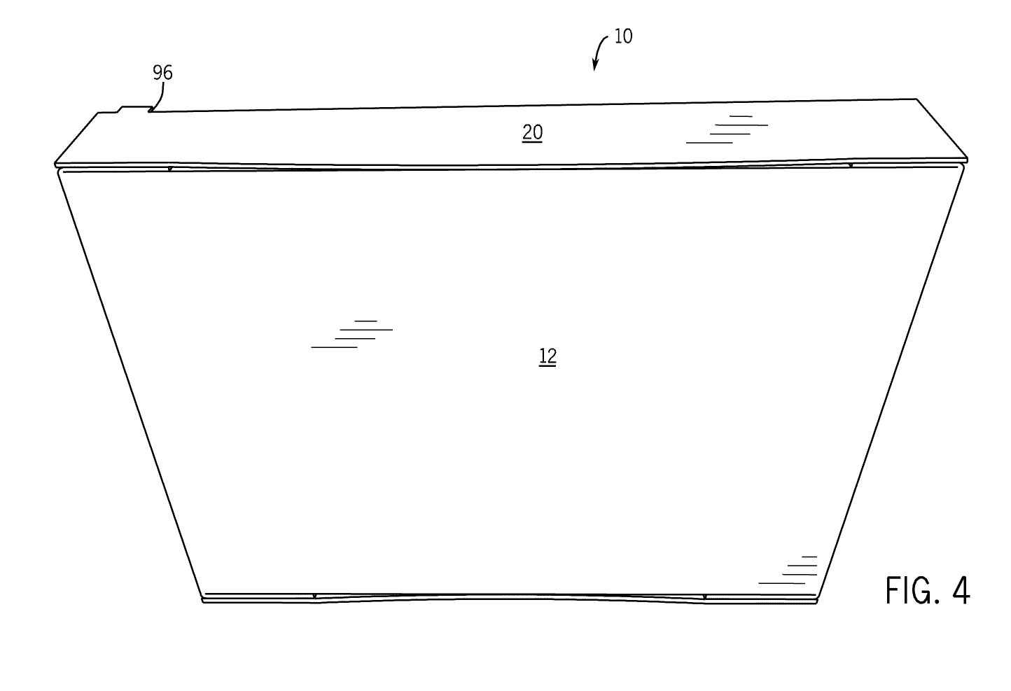

The blank 30 generally comprises a bottom panel 32 having a top face and a bottom face, which, when the blank 30 is foldably assembled to form the baking tray 10, forms the bottom 12 of the baking tray 10. The bottom panel 32 is generally rectangular, and is bounded by first and second side score lines 34, 36, and first and second end score lines 38, 40. When the blank 30 is formed into the tray 10, a shown in FIGS. 3 and 4, the tray 10 has a bottom 12, first and second end walls 14, 16 and first and second side walls 18, 20. Thus defined, the baking tray 10 comprises a generally rectangular, open-top box in the illustrated embodiment, though other configurations for the tray 10 are also contemplated.

The blank 30 further comprises first and second side panels 50, 52, connected to the opposite ends of bottom panel 32 at first and second side score lines 34, 36, respectively. When the blank 30 is foldably assembled to form the baking tray 10, the first and second side panels 50, 52 form the first and second side walls 18, 20, respectively, of the tray 10. The first and second side panels 50, 52 are generally mirror images of one another and, therefore, for purposes of brevity, only the first side panel 50 will be described in detail as the second side panel 52 is of similar construction to the first side panel 50. First side panel 50 preferably comprises a side wall panel 54 and a flap panel 56, connected to one another by means of a hinged fold joint 58, which will be described in greater detail below. In the illustrated embodiment, the side wall panel 54 is generally rectangular in shape, having a width equal to that of the bottom panel 32, and a height generally corresponding to the desired wall height of the side walls 18, 20 of the baking tray 10.

The hinged fold joint 58 comprises a central section 60 between the side wall panel 54 and the flap panel 56, and further comprises a retaining slit 64 disposed in the central section 60 adjacent one end of the fold joint 58. The central section 60 comprises a generally parallel pair of perforations or score lines 63a, 63b, the perforations or score lines being spaced apart from one another a distance, which is in one embodiment at least approximately twice the thickness of the laminated paperboard or corrugated paperboard comprising the blank 30, and preferably approximately four times the thickness of the laminated paperboard forming the blank 30 for ease of erecting the tray 10. Each of the parallel perforations or score lines 63a, 63b is of a length sufficient to facilitate the erecting or folding of the tray 10 and engagement with the end panels 70, 72, along with a knifecut (not shown) that can be provided between the interior ends of the perforations 63a, 63b.

The central section 60 can also have knifecuts (not shown) centered along perforations 63a and 63b to ensure the proper locking and holding position of the locked baking tray 10.

The blank 30 further comprises a first end panel 70 and a second end panel 72 which, when the blank 30 is foldably constructed into the baking tray 10, forms its first end wall 14 and second end wall 16, respectively, which are shorter in length than the first and second side walls 18, 20. The first and second end panels 70, 72 connect to the bottom panel 32 at first and second end score lines 38, 40, respectively. The first and second end panels 70, 72 are generally rectangular, having a length equal to that of the bottom panel 32, and a height corresponding to the desired wall height of the end walls 14, 16 and approximately equal to the height of the side wall panels 54.

Between the first end panel 70 and the adjacent side wall panels 54, corner webs or gussets 80 are provided. The two corner webs 80 are generally identical and, therefore, for purposes of brevity, only a single representative corner web 80 will be described in detail. As shown in FIG. 1, the corner web 80 connects to end panel 70 at a score line 82, and connects to side wall panel 54 at a score line 84. A diagonal score line 86 extends centrally along the corner web 80, between the adjoining corner of the bottom panel 32 and an outer corner 88 of the corner web 80. Additionally, for ease in erecting the tray 10, score line 86 can have a knifecut portion (not shown) provided. When erected, the corner webs 80 fold along lines 86 when end panel 70 and side panel 54 are positioned next to one another. The webs 80 can then be folded along lines 82 and 84 to position the webs in an overlapping position on the panels 54, such that the extension flap panels 56 can be folded over the webs 80 and secured to the webs 80 and to the side panel 54.

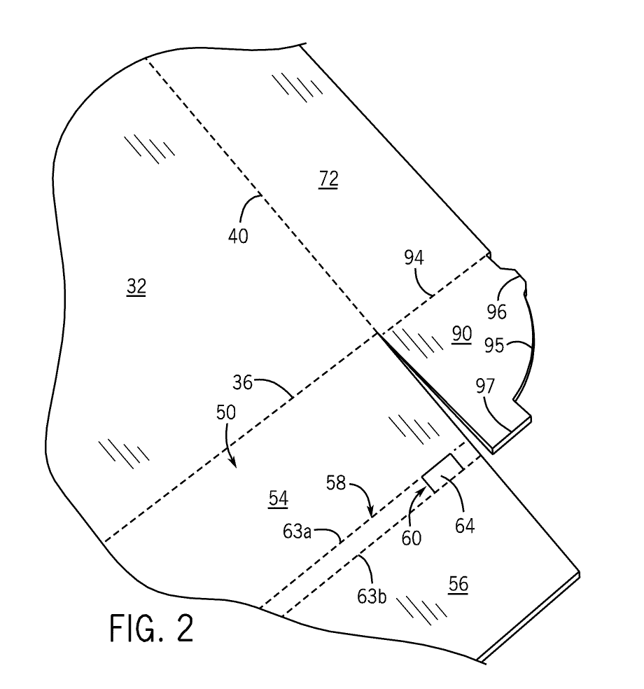

The end panel 72 includes a pair of end panel extensions 90 disposed at each end of the end panel 72, as best shown in FIG. 2, and are connected to the end panel 72 at a score line 94, but are separate from the adjacent side panel 54. Each extension 90 has a generally arc-shaped outer edge 95 on which are spaced a pair of locking tabs or members 96 and 97, with the locking member 96 being formed to be smaller in size than the locking member 97.

To erect the portion of the tray 10 including the end panel 72, after the side panels 54 have been folded relative to the bottom panel 32, the end panel 72 is moved to a position perpendicular to the bottom panel 32 along the score line 40, and the extensions 90 are each folded along the score lines 94 to position the extensions 90 against the side panels 54. In this position, when the flap panels 56 are folded over the extensions 90 using the fold joints 58, the locking member 96 on each extension 90 is disposed within the slit 64 in the fold joint 58, while the locking member 97 is disposed adjacent the bottom edges of the side panels 54 and flap panels 56. However, the flap panel 56 is engaged with the side panel 54, but not with the extension 90, such that the extension 90 can move with regard to the side panel 54 and flap panel 56.

However, in the assembled position, the locking member 96 protrudes upwardly through and engages the slit 64 to prevent the end panel 72 from being moved away from the side panels 54. Upon application of a significant amount of force, due to its reduced size the locking member 96 can be disengaged from the slit 64, such that the end panel 72 can be pivoted away from the side panels 54 along the score line 40 to provide access to the interior of the tray 10. The movement of the end panel 72 is limited by the position of the locking member 97 which, upon sufficient movement of the end panel 72 away from the side panels 54, the locking member 97 engages the slit 64 to prevent further movement of the end panel 72. This position is determined by the location of the locking member 97 on the extension 90, such that the position can be modified by moving the location of the locking member 97. In the illustrated embodiment, the locking member 97 is disposed on the extension 90 at a location where the locking member 97 engages the slit 64 when the end panel 72 is positioned parallel to the bottom panel 32.

In this configuration, the tray 10 provides an easily opened end panel 72 so that products in the tray 10 can be removed without deformation of the product by moving an end of the tray 10 back down into the flat blank 30 configuration. The disengagement of the locking member 96 from the slit 64 requires only a purposely directed, gentle urging to unlock the end 72 of the tray 10. To remove a baked product from the tray 10, for example a cake, one need simply fold the end wall panel 72 down. Thus, one does not need to place a spatula or the like at side, end or corner locations to “scoop out” a portion of the baked food product.

In addition, by doubling over the “length panel”, i.e., having the longer side panels 50, 52 formed with overlapping the side wall panels 54 and flap panels 56, this creates increased strength to the tray 10 along the direction of the longer side panels 50, 52. With this configuration, it is possible to reverse the corrugation of the material forming the tray 10 to be oriented in the short direction, i.e., parallel to the end walls 14, 16 and perpendicular to the side walls 18,20. This functions to greatly reduce the any bowing of the side walls 18, 20, and of the bottom panel 32, to enable the product held in the tray to be cut while present in the tray 10, and while still limiting any false scoring and the resulting damage to frozen product in the tray. Additionally, the portions of the central sections 60 moved to form the slits 64 can function as a stacking feature for the tray ton increase the ability of the tray 10 to be stacked and shipped.

Various other embodiments of the present invention are contemplated as being within the scope of the filed claims particularly pointing out and distinctly claiming the subject matter regarded as the invention.

1. A generally flat blank used to form an open-top container, the blank comprising:
a) a bottom panel bounded by end and side score lines;
b) first and second side panels connected to the opposite sides of the bottom panel at the respective side score lines, each of the first and second side panels having a flap panel, each flap panel connected to each side panel by a hinged fold joint;
c) a pair of end panels connected to opposite ends of the bottom panel at the respective end score lines.

2. The blank of claim 1 comprising at least one locking extension connected to one of the pair of end panels and having at least one locking member thereon that is releasably engageable with a retaining slit on the fold joint to selectively lock the one of the pair of end panels with regard to the first and second side panels.

3. The blank of claim 2 wherein the one of the pair of end panels is movable with regard to the first and second side panels and the flap panels.

4. The blank of claim 2 wherein the at least one locking extension includes a pair of locking members.

5. The blank of claim 4 wherein the pair of locking members are disposed on opposite ends of the at least one locking extension.

6. The blank of claim 5 wherein the at least one locking extension includes a curved edge, and wherein the pair of locking members at disposed at opposed ends of the curved edge.

7. The blank of claim 1 wherein the hinged fold joint comprises:
a) a central section;
b) a first score line disposed between the adjacent side panel and the central section; and
c) a second score line disposed between the adjacent end panel and the central section.

8. The blank of claim 7 wherein the central section has a width of at least twice the thickness of the material forming the blank.

9. The blank of claim 9 wherein the central section has a width of at least four times the thickness of the material forming the blank.

10. The blank of claim 1 wherein the blank is formed from a corrugated material, and wherein flutes in the corrugated material are oriented perpendicular to the first and second side flaps.

11. A container formed from the blank of claim 1.

12. A method of forming a tray comprising the steps of:
a) providing the blank of claim 1;
b) folding the blank to form the tray.
